(19) United States
(12) Patent Application Publication
(10) Pub. No.: US 2008/0313541 A1
(43) Pub. Date: Dec. 18, 2008

(54) METHOD AND SYSTEM FOR PERSONALIZED SEGMENTATION AND INDEXING OF MEDIA

(75) Inventors: Peter Shafton, San Francisco, CA (US); David A. Shamma, San Francisco, CA (US); Ryan Shaw, Berkeley, CA (US); Patrick Schmitz, San Francisco, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/763,388

(22) Filed: Jun. 14, 2007

(51) Int. Cl. G06F 3/00

(52) U.S. Cl. 715/725

(57) ABSTRACT

This disclosure describes systems, methods and user interfaces that allow a user to identify, annotate and share a portion of a media item with another user. Through the user interface, the user may render a media item and identify a segment of the media item. Based on the media item, previously defined and shared segments may be suggested to the user allowing the user to quickly select and identify popular segments for sharing. In addition, previously used annotations of previously defined and shared segments may be suggested to the user allowing users to quickly select annotations. The sharing user may then issue a command that causes a link or other means for accessing the segment to be transmitted to a recipient. Accessing this link or other means, causes the segment defined by the sharing user to be rendered on the recipient's device.

### BACKGROUND

The sharing of media items such as video clips and images is now common on the Internet. Systems are available that allow users to share entire media items via email, instant messaging software, web sites, blogs, and podcasts. In fact, the sharing of media items by individual users has become an important distribution mechanism for creators of popular content.

Sharing is common for small media items like short video clips. Sharing of large media items is less common as it requires more time on the part of the recipient to view the entire object.

One drawback of current sharing systems is that it is not convenient to share a segment, that is a small part of a media item. For example, a user may wish to share only a small segment of an episode of a newscast or popular television program, such as a specific 3 minutes of a 30 minute episode. Currently, to do this the user must first create a new media item containing only the 3 minutes that the user wishes to share. Creation of the new media item often involves obtaining a copy of the original media item, using specialized software to trim out the undesired content, and then uploading the new media item so that it can be shared. Because this process requires a significant amount of effort on the user's part, it has the effect of discouraging users from sharing segments of media items and reducing the amount of sharing of large media items.

### SUMMARY

This disclosure describes systems, methods and user interfaces that allow a user to identify, annotate and share a portion of a media item with another user. Through the user interface, the user may render a media item and identify a segment of the media item. Based on the media item, previously defined segments may be presented to the user allowing users to quickly identify popular segments. In addition, previously used annotations of previously defined segments may be suggested to the user allowing users to quickly select annotations. The sharing user may then issue a command that causes a link or other means for accessing the segment to be transmitted to a recipient. Accessing this link or other means, causes the segment defined by the sharing user to be rendered on the recipient's device. A sharing user and/or a recipient user may represent or embody a group of persons, such that a group of persons may share a link with another group of persons.

One aspect of the disclosure is a method for identifying and sharing segments of media items. The method includes receiving from a sharing user a request to share a segment of a video item with a recipient. The segment is identified by a start time marker and an end time marker, which may be displayed to and controlled by the sharing user to select the content of the segment. The sharing user may then cause the system to generate a link (or other access element) and transmit it to a recipient identified by the sharing user. The link, upon selection by the recipient, initiates playback of the video item on the recipient's device at the start time marker and ceases playback of the video item at the end time marker.

The link may be a link to a media server and may contain instructions for the media server to initiate playback at the start time marker. The start time may be included in the link or the link may include information that allows the media server to identify the start and end times from another source.

The method may include receiving an annotation related to the identified segment of the video item, and may include transmitting the annotation to the recipient user. Furthermore, the method may include displaying, suggested annotation to the sharing user based on previously generated annotations.

The method may include suggesting one, or more previously identified segments to the sharing user. A suggested segment may be selected by the user.

In another aspect, the disclosure describes a graphical user interface for sharing a segment of a media item. The graphical user interface includes a start time element disposed along a timeline element indicating the relative position of a start time within a media item of a segment of the media item. A preview window displaying video content from the media item is also displayed. The graphical user interface further includes a link send element that, when activated by a sharing user, sends a link to a recipient. The link, when activated by the recipient user, starts playback of the media item to the recipient user at the start time. The graphical user interface may be displayed in response to a request to share the media item.

The graphical user interface may also include an end time element disposed along the timeline element indicating the relative position of an end time within the media item of the segment so that when the link is activated, the recipient's device ceases playback of the media item at the displayed end time.

The graphical user interface may also include an address input element through which the sharing user may input an address of the recipient(s). An address suggestion element may also be provided which displays suggested addresses of potential recipients. An address book or access to an address book may also be provided for displaying one or more addresses which are selectable to designate the recipient user.

The graphical user interface may include an annotation input element that accepts an annotation for presentation to the recipient user with the link. An annotation suggestion element may also be provided that displays suggested annotations and selectively includes a suggested annotation for presentation to the recipient user with the link in response to a selection of the suggested annotation by the sharing user.

These and various other features as well as advantages will be apparent from a reading of the following detailed description and a review of the associated drawings. Additional features are set forth in the description that follows and, in part, will be apparent from the description, or may be learned by practice of the described embodiments. The benefits and features will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### A BRIEF DESCRIPTION OF THE DRAWINGS

The following drawing figures, which form a part of this application, are illustrative of embodiments systems and methods described below and are not meant to limit the scope of the disclosure in any manner, which scope shall be based on the claims appended hereto.

FIG. 1A illustrates an embodiment of a computing architecture for sharing segments of media items.

FIG. 1B illustrates another embodiment of a computing architecture for sharing segments of media items.

FIG. 2 shows an embodiment of a sharing graphical user interface for sharing a segment of a media item.

FIG. 3 shows a flow chart of an embodiment of a method 300 for sharing a segment of a media item.

FIG. 4 shows a flow chart of an embodiment of a method for suggesting a previously defined segment to a sharing user.

FIG. 5 shows a flow chart of an embodiment of a method for suggesting a previously used annotation for a segment to a user.

### DETAILED DESCRIPTION

The following description of various embodiments is merely exemplary in nature and is in no way intended to limit the disclosure. While various embodiments have been described for purposes of this specification, various changes and modifications may be made which will readily suggest themselves to those skilled in the art and which are encompassed in the disclosure.

As described above, the internet is increasingly being used to transmit, store, view and share media files. Entire online communities are developing which allow uploading, viewing, sharing, rating and linking to media files. These communities may use annotations to describe or categorize media files.

As used herein, the term “annotation” should be understood to include any information describing or identifying a media file. Examples of annotations include tags, as understood by those in the art. Other examples which may be used as annotations include hyperlinks, images, video clips, avatars or other icons, emotion icons, (e.g. “emoticons”) or other representations or designations.

The term “media item” as used herein may include any discrete media object (e.g., a media file), now known or later developed, including video files, games, audio, streaming media, slideshows, moving pictures, animations, or live camera captures. A media item may be presented, displayed, played back, or otherwise rendered for a user to experience the media item.

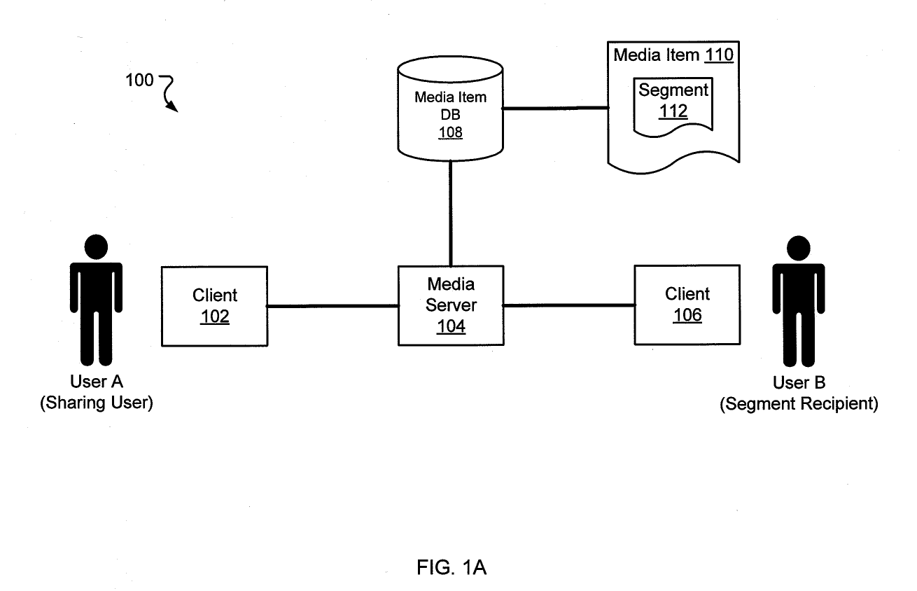

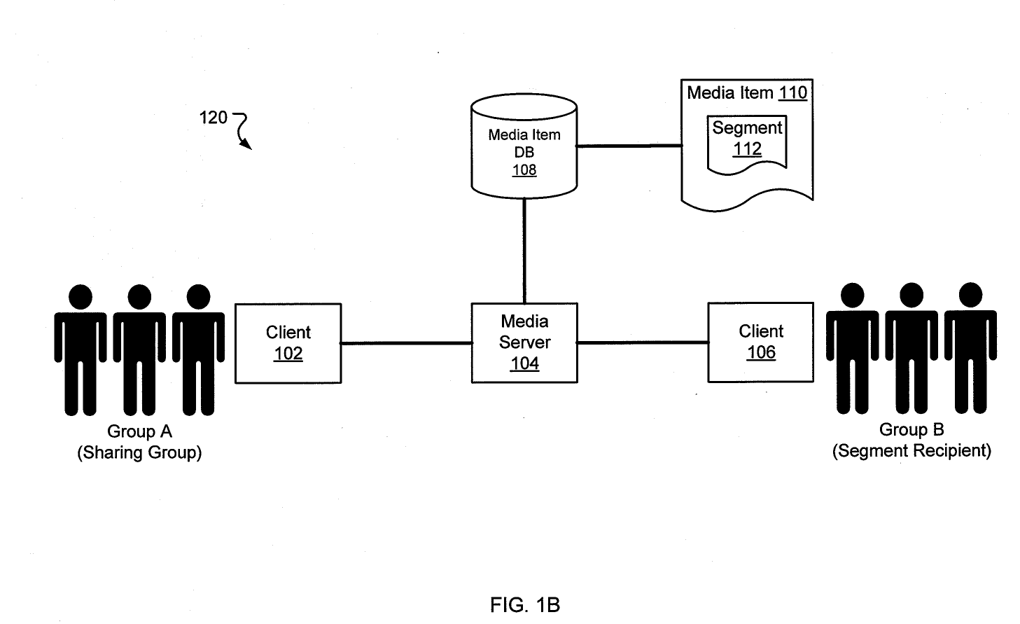

FIG. 1A illustrates an embodiment of a computing architecture for sharing segments of media items such as video clips and audio clips. The architecture illustrated in FIG. 1A is sometimes referred to as client/server architecture in which some devices are referred to as server devices because they “serve” requests from other devices, referred to as clients. In the embodiment shown, the architecture includes a client 102 operated by User A. Client 102 is connected to a media server 104 by a network such as the Internet via a wired data connection or wireless connection such as a wi-fi network, a WiMAX (802.16) network, a satellite network or cellular telephone network.

In the embodiment shown, the client 102, 106 and the server 104 represent one or more computing devices, such as a personal computer (PC), purpose-built server computer, a web-enabled personal data assistant (PDA), a smart phone, a media player device such as an IPOD, or a smart TV set top box. For the purposes of this disclosure, a computing device is a device that includes a processor and memory for storing and executing software instructions, typically provided in the form of discrete software applications. Computing devices may be provided with operating systems that allow the execution of software applications in order to manipulate data. In an alternative embodiment, one or more of the clients 102, 106 may be a purpose built hardware device that does not execute software in order to perform the functions described herein.

Through the media server 104, User A can access, download and render media items 110 on User A's device 102. In order to render media items 110, the client 102 may include a media player application (not shown), as is known in the art. Examples of media players include WINDOWS MEDIA PLAYER and YAHOO! MUSIC JUKEBOX.

When rendering media items or otherwise interfacing with the media server 104, the client 102 may display one or more graphical user interfaces (GUIs) to User A. A GUI displayed on the client 102 may be generated by the client 102, such as by a media player application, by the media server 104 or by the two devices acting together, each providing graphical or other elements for display to the user. By interacting with controls on the GUIs, User A can transmit requests to the media server 104 and generally control the accessing and rendering of media items 110 on the client 102.

Through a GUI, User A can communicate with the media server 104 to find media items 110 and have them rendered on the client 102. The media server 104 has access to one or more datastores, such as the media item database 108 as shown, from which it can retrieve requested media items 110. Media items may be stored as a discrete media object (e.g., a media file containing renderable media data that conforms to some known data format). Alternatively, depending on the type of content in the media item 110, a requested media item may be generated by the server 104 in response to a request.

In an embodiment, the datastore 108 may take the form of a mass storage device. One or more mass storage devices may be connected to or part of any of the devices described herein including any client 102, 106 or server 104. A mass storage device includes some form of computer-readable media and provides non-volatile storage of data for later use by one or more computing devices. Although the description of computer-readable media contained herein refers to a mass storage device, such as a hard disk, DVD-ROM drive or CD-ROM drive, it should be appreciated by those skilled in the art that computer-readable media may be any available media that can be accessed by a computing device.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

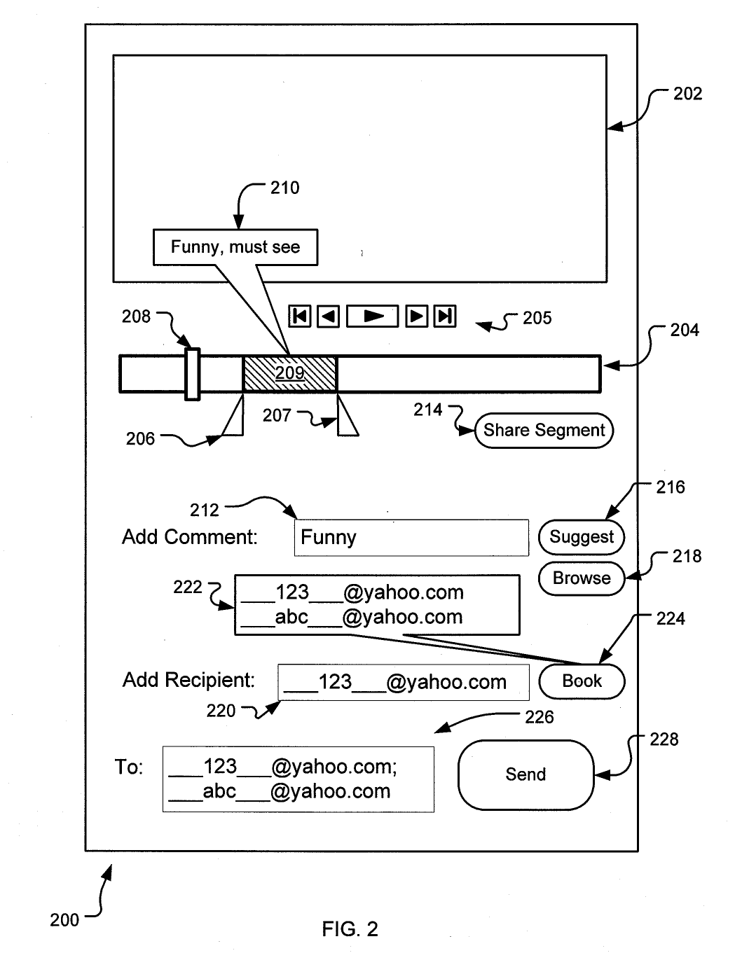

In the architecture 100 shown, User A desires to share a segment 112 of a media item 110 with User B operating a second client 106. User A indicates this by issuing a share media item request through a GUI to the media server 104. In response, a media item sharing GUI such as that shown in FIG. 2, is generated and displayed to User A.

As described in greater detail below, this sharing GUI allows User A to identify User B (and other users as well) as the recipient of the media item to be shared. In addition, the sharing GUI allows User A to identify a segment 112 of the media item 110 and share only that segment with User B. In response, the media server 104 transmits a message to User B's client 106. The message may be an email message, an instant message, or some other type of communication. Furthermore, through the sharing GUI User A may “embed” the segment into an electronic document such as a web page. Embedding, as discussed in greater detail below, may include creating a second media object containing only the segment 112 of the original media item 110. Alternatively, embedding may include generating a link or other control through which the segment 112 can be requested from the media server 104.

As discussed in greater detail below, when sharing a media item or a segment, User A is allowed to annotate the shared item or segment. The annotations may be stored by the media server 104 in an annotation store, which may or may not be the same datastore as that storing the media items. The user-provided annotations are retained by the server 104 as additional information known about the media items 110 and about any particular shared segments 112 of media items. Such annotations may be used by the media server 104 to make suggestions to later users about what segment 112 to choose and what media items 110 contain segments matching user-provided search criteria based on the contents of the annotations associated with the different segment. The information may also be used to suggest annotations to subsequent users for a media item or segment.

Other uses of the information are also possible that are not directly related to sharing media items 110, but rather to gathering information about media items and their use by members of a community. One use of sharing information and annotations includes making assessments of the relative popularity of a media item or segment based on the contents of the annotations and the number of times a segment or item has been shared.

FIG. 1B illustrates another embodiment of a computing architecture for sharing segments of media items such as video clips and audio clips. In the architecture 120, a Group A is a sharing group of people which together share as one user a segment with a different Group B which is a segment recipient. Group A may be a community of people from whom a link may be transmitted, such as through the direction of a Group A liaison or spokesperson. Group B may receive a link to a segment at an address such as a newsgroup, list serve or distribution list and individual people within Group B may thereby individually receive the link.

A segment recipient may be a group of people such as Group B or may be a single person (such as User B in FIG. 1A). In one embodiment, a sharing user (such as User A in FIG. 1A or Group A in FIG. 1B) may share a link with a recipient user such as Group B. For example, a sharing user may distribute a segment (via a link) to a group of people through addressing the link to a newsgroup or a distribution list.

A sharing user may be a group of people represented by a single address. In one embodiment, Group A may share a segment with a segment recipient. The segment recipient may be a group of people such as Group B, or may be a single person. The sharing user may send the segment (via a link) from a single address representing the sharing user.

FIG. 2 shows an embodiment of a sharing graphical user interface 200. Upon receipt of a command to share a media item, the GUI 200 may be generated or otherwise displayed to the user (the “sharing user”) issuing the command. The GUI 200 allows a sharing user to render the media item to be shared and to identify a segment to be shared if the user wishes to share only a portion of the media item. The GUI 200 further allows the sharing user to identify the recipient(s) of the media item or segment to be shared and then share, by sending or otherwise making accessible, the identified media item or segment.

The sharing GUI 200 includes a media item rendering window 202, a set of playback control elements 203 and a timeline element 204. Through the GUI 200, a user can control the rendering a media item in the rendering window 202, utilizing the playback control elements 205. The timeline element 204 provides a visual indicator, in the form of a present time marker 208, of where the content currently being rendered is within the media item. In an embodiment, playback of the media item may also be controlled by moving the present time marker 208 to a desired location (referred to as “scrubbing” by some in the art). In an alternative embodiment, the playback control elements 205 could be omitted, thus requiring the user to control rendering via the timeline element 204 only.

In addition to controlling the rendering of media items, the sharing GUI 200 includes a number of elements associated with sharing the media item. These sharing elements include elements for annotating what is to be shared, elements for defining a segment of the media item so that only the segment is shared, elements for identifying the recipient(s) and elements for sharing the media item or segment. Each of these elements will be discussed in turn below.

As discussed above, a sharing user may annotate shared media by providing text or other content (such as an image or icon) to be sent with the shared media item or segment. Textual annotations may be added via an annotation input element, such as text entry field 212. In addition, annotations may be suggested via annotation suggestion button 216, which may be triggered through typing into text entry field 212, through selection of an annotation suggestion button 216, or through other appropriate methods. It should be noted herein that control elements shown in FIG. 2 are not limited to the form in which they are illustrated, and any suitable control element could be used. Thus, the annotation suggestion button 216 could be replaced by some other control element through which the user could access the same functionality.

In the embodiment shown, sharing GUI 200 may also include an annotation browsing button 218. In the embodiment shown, user selection of the browsing button 218 allows a user to browse for annotations, such as media files, hyperlinks, avatars, and icons that have been pre-selected. The annotations may be generic annotations representing the most common annotations or may be annotations that have been previously associated with the media item by prior sharing users. The embodiment shown includes a typed annotation in text entry field 212 (“funny”).

In the embodiment shown, an optional annotation callout element 210 may display annotations as they are entered into an annotation input element (e.g., as they are typed into a text entry field 212) and/or may display suggested annotations (“must see”) as they are suggested to a user (e.g., displayed by an annotation suggestion request element 216). In an alternative embodiment, the annotation callout 210 may only be displayed to the sharing user if the user “mouses over” the segment area 209, described below, with a pointing device. In an embodiment, a suggested annotation may require selection by a user before it is displayed in annotation callout 210. In another embodiment, suggested annotations may be preliminarily displayed in annotation callout 210 and/or text field 212 and may need to be removed by the sharing user if the sharing user desires not to use the suggested annotation.

Suggested annotations and/or browsed-for annotations may be previewed in an appropriate preview window generated and/or displayed in response to the sharing user selecting the appropriate control. In an embodiment, a preview window may be annotation callout 210. In another embodiment, the preview window may be a suggested/browsed-for annotation preview element (not shown) separate from annotation callout 210.

It will be appreciated that, as shown in the embodiment in FIG. 2, the annotation input element is a text entry field 212 and the suggested annotation shown (“Funny, must see”) in the annotation callout illustrate text annotations. However, in another embodiment, annotations may be illustrated and suggested graphically (e.g., using media files, such as videos or images) or using other media files (e.g., audio files) as annotations. For example, a user may be able to “drag and drop” or access via the browse button 218 a media file for use as an annotation or use some other method of selection.

In addition, a sharing user may be able to designate how annotations are displayed to a recipient user, such as, through designating the interactions and selections which result in different effects when the recipient user views the link and/or the media item as accessed through the link. For example, a sharing user may designate a first level of annotations to be displayed when a recipient user receives and/or views a link, a second level of annotations when the recipient user first accesses a media item through the link, and a third level of annotations to be displayed in response to a selection of a media landmark by the recipient user. Each of the levels of annotations designated may be differentiated according to arbitrary differentiations made by the sharing user (e.g., the sharing user's choice) and may be differentiated according to types of annotations (e.g., media annotations versus text annotations), and/or descriptiveness of annotations (e.g., general annotations versus specific annotations).

GUI 200 also includes elements for identifying a segment to be shared. In the embodiment shown, associated with the timeline element 204 are time markers representing a start time marker 206 and an end time marker 207 of a portion of the media item. In addition, in the embodiment shown the start time marker 206 and end time marker 207 define a segment area 209 showing where the segment appears on the timeline 204. The markers 206, 207 may be displayed automatically with the GUI 200, for example defaulting to identify the entire media item when the GUI 200 is initially displayed. Furthermore, if there are one or more known segments in the media item that have been previously identified or shared, the GUI 200 may automatically show one or more of these on the timeline 204 as suggested segments with suggested annotations such as by showing additional segment areas 209 on the time line or by showing only suggested start time markers. Alternatively, the markers 206, 207 may be displayed upon receiving a command from a sharing user, such as when the sharing user selects a share segment button 214 as shown or upon selection of the suggest button 216.

By selecting and moving the markers 206, 207 the sharing user may specify the exact media segment to be shared. When selected and moved, the video displayed in the rendering window 202 may show a video frame or other content associated with the currently selected marker 206, 207 to assist the sharing user in identifying the exact start and end point of the segment.

Sharing GUI 200 may also include an address input element such as text entry field 220. Other address input elements may also be included, including graphical representations of users and/or aliases of users, such as avatars, images, icons, user names, or nicknames. Users may have several different addresses and a different representation for each address. For example, a user may have a representation of a user for each way of contacting that user (e.g., through a different address).

In the embodiment shown, sharing GUI 200 includes an address book selection element 224, which, when selected, may bring up an address selection GUI (not shown) containing the sharing user's contact list, an address suggestion callout 222 may appear in GUI 200, or both may be provided. Address suggestion callout 222 may include a list of recent addresses to which the sharing user has sent any item including a link to a media item, an e-mail, an instant message, or another communication. In another embodiment, address suggestion callout 222 may include addresses related to and/or similar to an address entered into address input element (shown in FIG. 2 as a text entry field 220). In one embodiment, addresses may be suggested by determining the last user with which the sharing user has discussed a media item containing a similar annotation. In another embodiment, addresses can be suggested based on other users with which the sharing user has recently shared other media items, or may be based on other users with which the sharing user has recently had conversations. There may be other criteria for suggesting recipient users and their addresses.

It will be appreciated that, as shown in the embodiment in FIG. 2, the address input element 220 is a text entry field and the suggested addresses shown are text addresses. However, in another embodiment, addresses may be inputted and suggested graphically (e.g., using representations of addresses, such as icons or images) or using other elements to represent users. For example, a user may be able to “drag and drop” an icon representing an address or use some other method of selection.

Users may have multiple addresses such as addresses representing multiple ways of communicating with the user. In one embodiment, multiple addresses of a recipient user may be represented by a single address or a single address icon, nickname or other representation of the recipient user. For example, an icon or nickname for a recipient user may allow a sharing user to reach the recipient user at various different addresses for communicating via, for example, an email account and a mobile phone with the recipient user. As discussed further below, different communications (e.g., link, link plus media annotation, text message stating that a link has been sent to another communication device) can be made with different communication devices, depending on the types of communications the devices are adapted to receive.

Address confirmation element 226 displays addresses of recipient users to whom a link will be sent. Addresses may be entered through an address input element, through an address suggestion GUI 222, or otherwise as based on selection by a sharing user. As described above with respect to annotations, addresses may be inserted into address confirmation element 226 automatically based on suggestion of the address (e.g., the “______ abc ______ ” address in address confirmation element 226) automatically or without affirmative selection by the sharing user. Also as described above with respect to annotations, a suggested address from address suggestion callout 222 may be added based on affirmative selection by the user (e.g., a mouse-related selection of an address in the address selection callout 222).

In the embodiment shown, sharing GUI 200 includes a send button element 228, which causes the identified media item or segment to be shared with the recipient(s) identified in the address confirmation element 226. In one embodiment, discussed in greater detail below, user selection of the send button 228 causes a link to be transmitted to the recipient(s) through which the recipients can access the shared item or segment. A request from a user to send the link may be received through a send element 228, as shown in FIG. 2, or may be through another selection by a sharing user of a part of the sharing GUI 200, or through another input from the sharing user (e.g., a keyboard input, such as a carriage return).

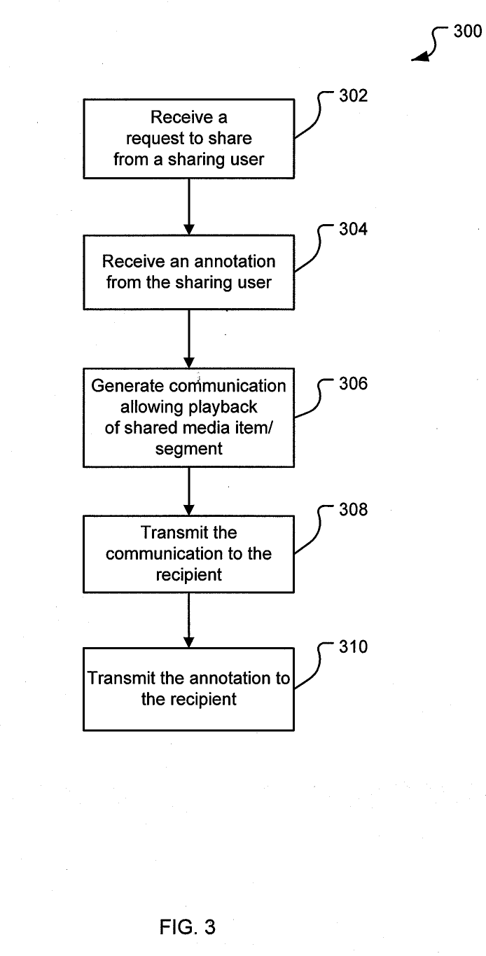

FIG. 3 shows a flow chart of an embodiment of a method 300 for sharing a segment of a media item. The method 300 could be used to transmit a link providing access to a media item segment or to transmit a new media item generated to include only the segment identified by the sharing user. The method 300 includes transmitting to the recipient any annotations associated with the link (or other means for accessing the media item), along with an annotation related to the media item.

In the method 300, a request is received in a receive share request operation 302 from a sharing user to share a media item or segment. In response to this request, a sharing GUI such as the GUI shown in FIG. 2 may be displayed to the user for the media item identified. The sharing GUI may need to be generated by the media server or some other component of the system.

In any case, as further described above, an annotation is received from the sharing user in a receive annotation operation 304. This annotation may be an annotation that was suggested via the sharing GUI or could be a new annotation provided by the sharing user. As part of receiving the annotation, the system may store some information recording the sharing of the media item. For example, any new annotation associated with a media item or segment may be stored for later use, as described above. Alternatively, the system may store this information as some other point in the method 300.

In an embodiment of the method, the annotation and request to share are received as a combined operation. For example, the annotation may be received as part of a request generated by a sharing user selecting the send button 228 as shown in FIG. 2.

The method 300 includes generating a message for the recipient in a generate communication operation 306. Depending on the mode of communication selected, the message could be an email message, an instant message or some other type of communication.

The generate communication operation 306 may include generating a link in the message which, upon selection by the recipient, initiates playback of the media item segment. For example, the link may take the form of an icon or hyperlinked text in the generated message. The link may include information such as an identification of the media item, the start time and the end time. Alternatively, the information in the link could be any information that identifies the segment to being shared. For example, instead of a media item, start time and end time, the information could be a media item identifier, a start time and duration or even simple code that the media server can use to find a definition of the shared segment stored on the server.

For example, in an embodiment, the link generated may include the start time marker and may be a link to an unmodified version of the media item. A link including a start time marker at 2:11 into the media item may reference that media item in its unmodified form. In other words, accessing the unmodified media item without the start time marker will begin playback of the media item at 0:00. A start time marker may be included in the link generated as an instruction to initiate playback at the start time marker, or otherwise may be encoded in the link. In another embodiment, the link generated 306 is a link to a modified media item which has been modified (e.g., trimmed) to initiate playback at the start time marker. For example, if a start time marker is at 2:11, a modified media item may have been trimmed to exclude the portion before the start time marker of 2:11.

In one embodiment, a modified media item may be created specifically for a link included in a message sharing the media item segment. For example, a media item may be modified and/or trimmed to initiate playback at a start time marker associated with the link and may be stored as a discrete media item on the media server. In another embodiment, a modified media item may include a plurality of indexed start time markers, and a link may contain reference to one of the indexed start time markers. For example, a media item with a plurality of shared segments may include an indexed start time marker for each of the segments, and the link may reference one of the indexed start time markers associated with one of the segments. In this embodiment, a sharing user may select a predetermined and suggested start time (and, possibly, end time) for a segment at which to begin a shared portion of the media item, and the link generated based on this share request may include an identifier of the indexed start time marker.

It will be appreciated that the above discussion is also relevant to and may be equally applied to embodiments including end time markers and embodiments using end time markers to cease playback of a media item at a particular end time. As an example, an end time marker may be included in a link to an unmodified media item in order to cease playback of the media item at the end time marker. As another example, an end time marker, such as 9:01, may be used to modify a media item such that playback of the media item ceases to at 9:01 (e.g., through trimming the media item, through placing an indexed end time marker in the media item).

In the embodiment shown, after the message is generated, it is transmitted to the identified recipient(s) in a link transmission operation 308. Depending on the type of communication selected by the sharing user, transmitting the link to the recipient may require different transmission paths. For example, if a recipient user is located at an address over a particular network, that network may be used to transmit the link to the recipient user. Various protocols such as instant messaging, e-mail, text messaging, or other communication protocols and/or channels may be used as appropriate.

In the embodiment shown, the annotation is also transmitted in an annotation transmission operation 310. The annotation transmission operation 310 is illustrated as a second operation to remind the reader that the annotation need not be transmitted to the recipient as part of the same message or in the same way as the link or media item is transmitted in the link transmission operation 308. The annotation may be transmitted with the link to the recipient or the annotation may be transmitted separately from the link to the recipient user. Communication protocols and channels may suggest or dictate how a link and an annotation are transmitted 308, 310 to a recipient user (e.g., bundled, grouped, separated, associated). For example, an annotation which is a media item may be bundled differently with the link than an annotation which is a text annotation, depending on the communication protocol and/or channel used in transmitting the link and transmitting the annotation.

In one embodiment, the communication protocol and/or channel used to transmit the link or media item to the recipient is different than the communication protocol and/or channel used to transmit an annotation to the recipient. For example, a link may be transmitted to a recipient on the recipient user's mobile or smart phone and an annotation may be transmitted to the recipient user at a recipient user's network address (e.g., e-mail address). The use of multiple addresses of a recipient is further described above.

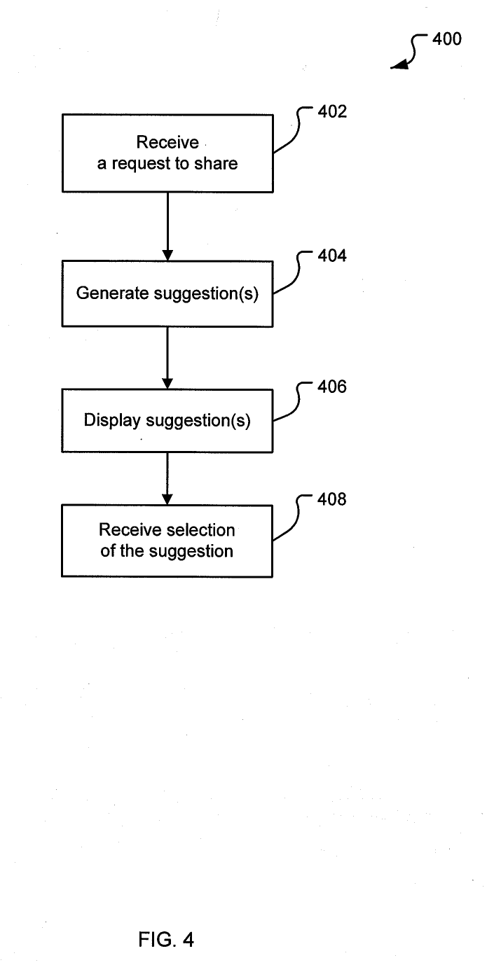

FIG. 4 shows a flow chart of an embodiment of a method 400 for suggesting a suggested time to a user. The method starts when a share request is received from a user. The share request may be a command to share a segment or may be a request to open a GUI, such as that shown in FIG. 2, from which the sharing user may identify what is to be shared. The share request may also be a request to display a GUI associated with rendering a media item that is adapted to include some or all of the sharing control elements described above.

In response to the request, a suggested segment is generated in a generate suggestion operation 404. This operation 404 may include accessing information known about the identified media item and any previously shared or annotated segments thereof. The operation 404 may also include comparing this information with information known about the sharing user, in order to identify the segments most likely to be of interest to the sharing user. For example, if the sharing user has a history of sharing funny segments or segments associated with car racing crashes, this user interest information may be used to identify previously annotated and/or segments with the same or similar subject matter.

In one embodiment, a suggested segment may be created based on a user selection of a time marker. In another embodiment, a suggested segment may be created in response to a user's modification of a time marker. For example, as the sharing user scrubs through the media item, different suggested segments and/or their annotation may be displayed.

For media items with many different possible suggested segments, the generate suggestion operation 404 select only those previously identified segments that are the most popular or recently shared segments. For example, a popular segment may exist near a start time marker which a user has initially selected, and a suggested start time may be generated from the popular start time. For the purposes of this disclosure near may be determined by some predetermined absolute threshold such as within 5 seconds, within 10 seconds, within 30 seconds, etc. Alternatively, near may be determined by looking at how much of the segments overlap, e.g., if 90% of the segment overlaps with the previously generated segment, then the start time may be considered near the start time of the sharing user's currently identified segment. As an example, a user may select a start time marker initially at a time of 4:22, yet a popular start time may be at 4:18, and a suggested start time marker may be created and displayed to the sharing user for the popular time (e.g., 4:18).

In the embodiment shown, after a suggested segment is generated, the suggested segment is displayed in a display suggestion(s) operation 406. The suggested segment may be displayed to a user in a number of ways. In one embodiment, if a user moves a time marker and a suggested segment is created in response thereto, then the suggestion is displayed through a pop-up element such as a callout, a separate GUI, or other means for indicating the suggested segment. In yet another embodiment, a suggested segment may be displayed in response to an adjustment made to a user's positioning of a time marker near to a start or end time of a popular or otherwise predetermined segment. For example, a user's modification of a time marker may be adjusted to equal a popular time when the user moves the time marker to within some threshold amount of time near a predetermined segment. In other words, predetermined segments may be presented to users as having a gravitational-type effect on the user's modification of a time marker as it approaches the segment.

A suggested segment may be illustrated as a segment to the user such as via the segment element 206 shown in FIG. 2. Alternatively, the suggested segment may be displayed only as small markers located at a segment's start time. The displaying of a suggested segment may also include displaying the content or video frame associated with the start time of the segment in the render window of the GUI. In this way, the sharing user may initiate playback of the suggested segment easily. This may be achieved by automatically moving the present playback marker to the start time of the suggested segment when a suggestion is displayed or selected by the sharing user.

After the suggestion is displayed, the sharing user may then select the suggested segment. In one embodiment, the selection received from a user of the suggested segment is an active selection of the suggested segment, such as a mouse-related selection, keyboard-related selection, or other active user indication that the suggested segment is acceptable.

In another embodiment, the selection may be implied from the user's actions. For example, an inactive selection of the suggested segment may be a user's failure to respond to a display of the suggestion. For example, a user's sending of the link without altering or resetting the time marker after the automatic movement to the start or end of a popular segment nearby (with or without a commensurate numerical display of the popular segment) may be considered a selection of the suggested segment.

The user's selection is then received by the system in a receive selection operation 408. The receive selection operation 408 may include receiving a share request that identifies the suggested segment as the shared segment. This information may then be used as described with reference to FIG. 3 above to transmit the suggested segment or link thereto to a recipient.

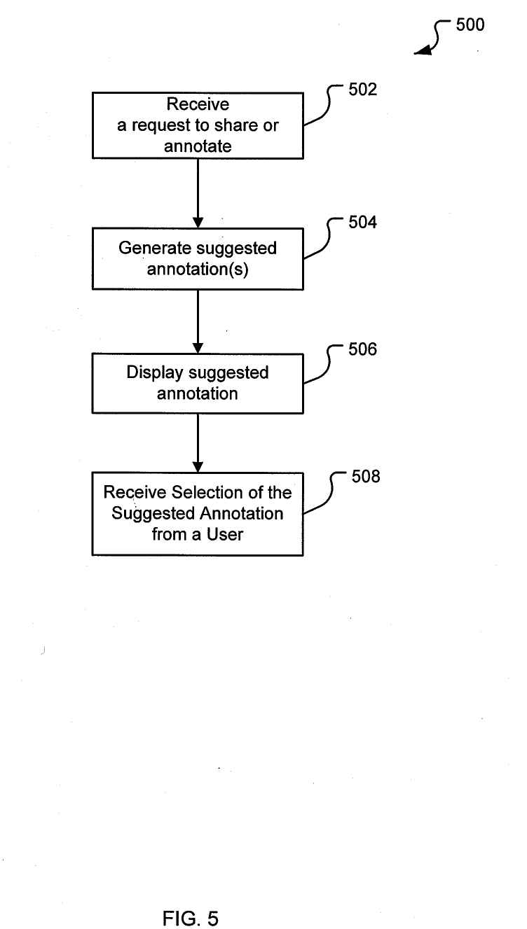

FIG. 5 shows a flow chart of an embodiment of a method 500 for suggesting a suggested annotation to a user. The method starts when a share request is received from a user in a receive request operation 502. The share request may be a command to share a segment or may be a request to open a GUI, such as that shown in FIG. 2, from which the sharing user may identify what it to be shared. In yet another embodiment, the request received may be a request to open a GUI associated with rendering a media item that is adapted to include some or all of the annotation control elements described above.

In response to the request, a suggested annotation is generated in a generate suggested annotation operation 504. This operation 504 may include accessing information known about the identified media item and any previously shared or annotated segments thereof. The operation 504 may also include comparing this information with information known about the sharing user, in order to identify the segments most likely to be of interest to the sharing user. For example, if the sharing user has a history of frequently annotating segments with specific annotations, this user interest information may be used to identify annotations for segments that correspond to the user's previous annotation history.

In an embodiment, the generate suggested annotation operation 504 may be combined with an operation such as the generated suggested segment operation 404 to simultaneously identify segments and associated annotations for display to the sharing user.

In an embodiment, a suggested annotation may be created based on a user selection of a time marker. In another embodiment, a suggested annotation may be created in response to a user's modification of a time marker. For example, as the sharing user scrubs through the media item, different suggested annotations and/or their annotation may be displayed, based on the underlying annotations associated with the segments being scrubbed through.

In an embodiment, a suggested annotation may be created based on a user selection or entry of an annotation. For example, a user's selection of an annotation may be used to match the annotation to a similar, related, or more popular annotation. For example, a user may input “zzz” as an annotation and the operation 504 may adjust the annotation with a more standardized annotation, e.g., “Zzzzz”, with the same meaning.

In one embodiment, a suggested annotation may be created based on a popular annotation associated with the currently identified media item or segment. For example, a popular annotation may be similar to an annotation which a user has initially selected, and a suggested annotation may be created from the popular annotation. As an example, a user may select annotation initially (e.g., type an annotation into a text entry field, select a video clip as an annotation), and a popular annotation may be similar (e.g., a similar text string, a different video clip, a video clip trimmed differently), and a suggested annotation may be created to match or be more similar to the popular annotation.

In the embodiment shown, after a suggested annotation is created, the suggested annotation is displayed in a display suggestion operation 506. The suggested annotation may be displayed to a user in a number of ways. In one embodiment, if a user selects an annotation (e.g., types part of a text string, initially selects an image) and a suggested annotation is created in response thereto, then the suggested annotation may be displayed through a pop-up element, a callout, a drop down box, a separate GUI, or other means for indicating the suggested annotation. In another embodiment, a suggested annotation may be displayed nearby the media item being annotated in order to guide a user to a popular annotation. For example, as a sharing user is editing which annotations will be associated with a portion of a media item to be shared with a recipient, popular annotations for the media item or segment may be displayed to easily allow the sharing user to select and associate those annotations with the portion of the media item.

After the suggestion is displayed, the sharing user may then select the suggested annotation. In one embodiment, the selection received from a user of the annotation may be an active selection, such as a mouse-related selection, keyboard-related selection, or other active user indication that the annotation is acceptable.

In another embodiment, the selection may be implied from the user's actions. For example, an inactive selection of the suggested annotation may be a user's failure to respond to a display of the suggestion. For example, a user's sending of the link without altering or removing the suggested annotation after the annotation is suggested may be considered a selection of the suggested annotation.

The user's selection is then received by the system in a receive selection operation 508. The receive selection operation 508 may include receiving a share request that identifies the suggested annotation as an annotation for the shared segment or media item. This information may then be used as described with reference to FIG. 3 above to transmit the suggested segment or link thereto to a recipient.

With reference to the systems and methods described, it should be noted that a sharing user may be a member of a group or a defined community of users. These may be explicit associations in which the user must actively join the group or community or implicit association based on information known about the various users. For example, college educated males between the ages of 40 and 50 may be treated as a community by a system, particularly when trying to evaluate suggestions or preferences that are applicable to all within that community.

A community of users may be used by the methods and systems described herein to create suggestions of addresses, annotations, time markers and/or other relevant information for a user. For example, a user's community of users may be a source of relevant usage data of other users with known similar tastes or known differing tastes for the user.

Addresses suggested to a sharing user may be preferentially suggested from the sharing user's community of users as well as from the sharing user's history of recipient addresses. Addresses from a user's community and history may be represented in different ratios in such suggestions, as appropriate.

Segments and/or times for time markers (e.g., start time markers, end time markers, time markers for annotation in the middle of a portion of the media item) may be suggested by evaluating other start times shared by other users in order to determine which may be popular to the particular sharing user. In one embodiment, users within the sharing user's community of users may be weighted in order to produce more relevant popular start times for the sharing user.

Annotations may be suggested by evaluating other annotations shared by other users in order to determine which annotations are popular. In one embodiment, users within the sharing user's community of users may be weighted in order to produce more relevant popular annotations for the sharing user.

Elements of the media sharing systems described herein may be implemented in hardware, software, firmware, any combination thereof, or in another appropriate medium. The systems described herein may implement methods described herein. In addition, methods described herein when implemented in hardware, software, firmware, any combination thereof, or in another appropriate medium may form systems described herein.

The descriptions of the methods and systems herein supplement each other and should be understood by those with skill in the art as forming a cumulative disclosure. Methods and systems, though separately claimed herein, are described together within this disclosure. For example, the parts of the methods described herein may be performed by systems (or parts thereof) described herein.

In addition, the methods described herein may be performed iteratively, repeatedly, and/or in parts, and some of the methods or parts of the methods described herein may be performed simultaneously. In addition, elements of the systems described herein may be distributed geographically or functionally in any configuration.

1. A method comprising:
receiving from a sharing user a request to share with a recipient user an identified segment of a video item bounded by a start time marker and an end time marker;
generating a link which upon selection by the recipient user initiates playback of the identified segment to the recipient user; and
transmitting the link to the recipient user.

2. The method of claim 1, wherein the link when selected by a user generates a render request to a media server and the method further comprises:
receiving a render request from The recipient user generated by the recipient selecting the link; and
transmitting the video item to the recipient user starting at the start time marker and ceasing at the end time marker.

3. The method of claim 1, further comprising:
including the start time marker in the link.

4. The method of claim 1, further comprising:
receiving an annotation related to the segment of the video item; and
transmitting the annotation to the recipient user.

5. The method of claim 4, further comprising:
transmitting to the recipient user a first suggested annotation previously associated with a previously defined segment having a start time or an end time near one of the start time marker and the end time marker.

6. The method of claim 4, further comprising:
transmitting to the recipient user a second suggested annotation previously associated with a previously defined segment having a start time or an end time between the start time marker and the end time marker.

7. The method of claim 1, further comprising:
in response to the request to share the identified segment of the video item with a recipient user, displaying a timeline associated with the media item to the sharing user; and
displaying on the timeline a suggested start time marker associated with a previously defined segment having a different start time and end time than the identified segment.

8. The method of claim 7, further comprising:
displaying a video frame associated with suggested start time marker in a render window.

9. The method of claim 7, further comprising:
placing a present time marker at the same point as the suggested start time marker.

10. The method of claim 6, further comprising:
identifying any previously defined segments that overlap the identified segment by more than a predetermined amount.

11. The method of claim 1, further comprising:
in response to the request to share the identified segment of the video item with a recipient user, displaying a timeline associated with the media item to the sharing user; and
displaying on the timeline an indicator identifying a suggested segment of the media item having a different start time and end time than the identified segment.

12. The method of claim 11, wherein the indicator identifies a start time of the suggested segment on the timeline.

13. (canceled)

14. The method of claim 12, further comprising:
receiving a selection of the suggested segment from the sharing user whereby the suggested segment becomes the identified segment.

15. The method of claim 14, further comprising:
displaying a suggested end time marker on the time line identifying the end time of the suggested segment to the sharing user.

16. The method of claim 1, wherein the link, upon selection by the recipient user, initiates playback of the video item at the start time marker via accessing a modified video item which is trimmed to start at the start time marker.

17. The method of claim 1, wherein the link, upon selection by the recipient user, initiates playback of the video item at the start time marker via accessing the video item at the start time marker.

18. (canceled)

19. The method of claim 1, further comprising:
receiving an address of the recipient user as part of the request; and
transmitting a communication containing the link to the address.

20. The method of claim 19, further comprising:
receiving an annotation as part of the request;
including the annotation in the communication; and
storing information associating the annotation with the identified segment.

21. (canceled)

22. A graphical user interface for sharing media items comprising:
a start time element disposed along a timeline element indicating the relative position of a start time within a media item;
a preview window displaying video content from the media item; and
a link send element that, when activated by a sharing user, sends to a recipient user a link that, when activated by the recipient user, starts playback of the media item to the recipient user at the start time.

23. The graphical user interface of claim 22, wherein the graphical user interface is displayed in response to a request to share the media item.

24. The graphical user interface of claim 22, further comprising:
an end time element disposed along the timeline element indicating the relative position of an end time within the media item;
wherein the link, when activated by the recipient user, causes playback of the media item for the recipient user to cease at the end time.

25. The graphical user interface of claim 22, further comprising:
an address input element through which the sharing user may input an address of the recipient user; and
an address suggestion element which displays suggested addresses of potential recipient users in response to text entry into the address input element.

26. (canceled)

27. The graphical user interface of claim 22, further comprising:
an address book graphical user interface displaying one or more addresses which are selectable to designate the recipient user.

28. The graphical user interface of claim 22, further comprising:
an annotation input element that accepts an annotation for transmission with the link and presentation to the recipient user.

29. (canceled)

30. The graphical user interface of claim 22, further comprising:
an annotation suggestion element that displays suggested annotations and selectively includes a suggested annotation for presentation to the recipient user with the link in response to a selection of the suggested annotation by the sharing user.
